(19) United States
(12) Patent Application Publication
(10) Pub. No.: US 2018/0125033 A1
(43) Pub. Date: May 10, 2018

(54) LIVESTOCK WATER TROUGH

(71) Applicant: Sahid Julio MANZUR OLIVEIRA, Montevideo (UY)

(72) Inventor: Sahid Julio MANZUR OLIVEIRA, Montevideo (UY)

(21) Appl. No.: 15/383,445

(22) Filed: Dec. 19, 2016

(30) Foreign Application Priority Data
Nov. 8, 2016 (UY) U-4629

(51) Int. Cl. A01K 7/04

(52) U.S. Cl. CPC A01K 7/04

(57) ABSTRACT

The present utility model refers to a livestock water trough with a design that makes it suitable for use by all types of livestock (cattle, horses, sheep, etc.), which does not need to be adapted to the specific type of livestock that uses it, since water supply is at ground level, as animals naturally drink it, and without the possibility of contamination of the water by the animals' legs.

The present utility model refers to a livestock water trough; in particular, it refers to a water trough with a design that makes it suitable for all types of livestock (cattle, horses, sheep, etc.) with no need to adapt it to the specific type of livestock that uses it.

### BACKGROUND

All modern and old technology referring to livestock water troughs that can be found in the state of the art, explicitly expressed or not, is based on a valid principle: animals should not contaminate the water they drink.

The most frequent form of contamination of water drunk by animals occurs due to the introduction of legs in the container or water trough. To avoid this, in the last years, technology has given two basic efficient answers that we will number A and B:

A) It consists of finding a solution to water troughs located on the floor, protecting them with walls or edges high enough to prevent the introduction of animals' legs into the container or trough. B) It consists of elevating the vessel or trough to the necessary height to prevent the animals from placing their legs into them.

For example, utility model ES1072150U is not an exception, since it expressly indicates that the system can be placed at a “suitable height” for the animal to drink. Said “adequate height” means that according to the type of animal that will use it, the water trough must be raised from the ground up to a height sufficient for the animal to reach it without problems.

Obviously, this height is not the same for sheep than for horses or cattle. In the current state of the art, different types of water troughs (supported or suspended) are adapted specifically for the various types of animals that will use them and, therefore, if a water trough is adapted for a horse, a sheep will not be able to use it.

Surprisingly, the water trough designed in the present utility model solves all these problems very simply. It is a completely new and functional design that has no antecedents.

### DETAILED DESCRIPTION OF THE INVENTION

One of the advantages of this utility model is that any type of livestock (sheep, cattle, horses, etc.) can use it, since it has a single position, equally accessible for all animals.

Another advantage of the present trough is that, regardless of the way of supplying water, the trough is at floor level, and yet the animals do not place their legs into it. In fact, animals drink water as if they were drinking from a stream, watering place, lagoon or river, but without the possibility of contaminating the water with their legs, because the design of this water trough inhibits them from introducing both front and hind legs.

Thus, the fundamental inventive merit of the present trough is the possibility of supplying water to animals as they naturally drink it, i.e. at ground level, and without the possibility of contaminating the water with their legs.

### BRIEF DESCRIPTION OF THE DRAWINGS

In order to better understood, the object of the present utility model, a preferred embodiment is shown in FIGS. 001 to 013, susceptible to minor changes that do not alter the original design:

FIG. 001: Axonometric projection of the trough with a float protector.

FIG. 002: Axonometric projection of the float protector.

FIG. 003: Axonometric projection of the trough with a float protector, view 2.

FIG. 004: Horizontal projection without a float protector.

FIG. 005: Cross-section A-A without a float protector.

FIG. 006: Longitudinal section B-B without a float protector.

FIG. 007: Longitudinal facade with a float protector.

FIG. 008: Section B-B with a float protector.

FIG. 009: Horizontal projection of the trough with a float protector.

FIG. 010: Bottom of container, without a float protector.

FIG. 011: Description “X”.

FIG. 012: Supply description/shutting off, shut off.

FIG. 013: Supply description/shutting off, open.

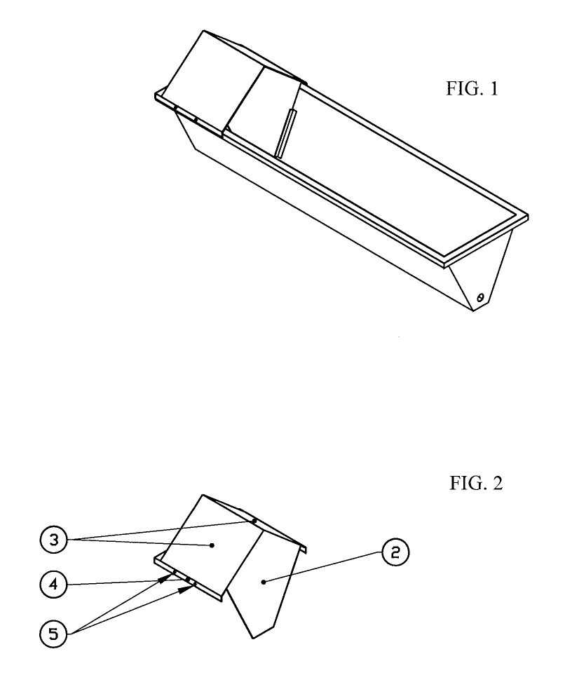

### DESCRIPTION OF PREFERRED EMBODIMENT

The trough described in this utility model can be constructed from any waterproof material with a relative mechanical resistance. In particular, it can be constructed from metal (galvanized, stainless steel, painted sheet), reinforced concrete (with iron, with plastic fibers), ferrocement, and any kind of wood or any plastic material commonly used in conventional troughs.

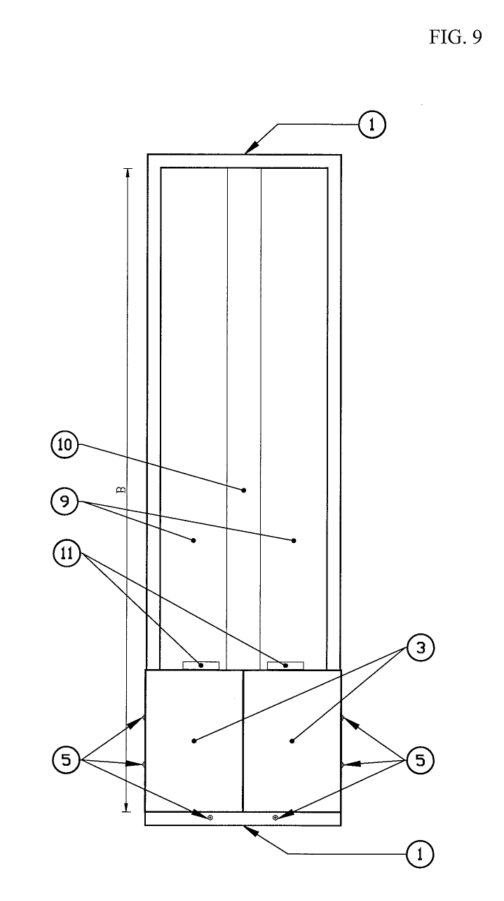

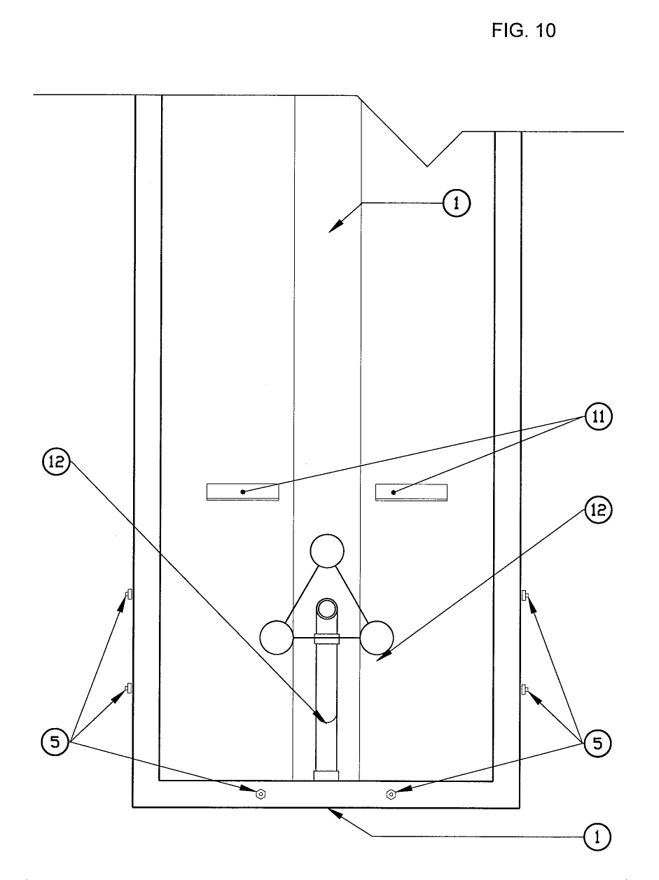

The receptacle that contains water and that effectively functions as a drinking trough consists of a container or trough of horizontal rectangular projection, which is placed at ground level, or semi buried. In FIG. 003, it can be observed that the sides (6) of the trough are trapezoidal and the longitudinal sides (9) are rectangular and inclined. The bottom of the container is shown in FIG. 10).

Water is supplied through an orifice (1) from an underground pipe. Water supply is controlled by any type of faucet commanded by a float and the faucet can be installed either inside the container or trough—as shown in the attached figures—or outside the receptacle or trough. In the latter case, the faucet con control one or more containers or troughs.

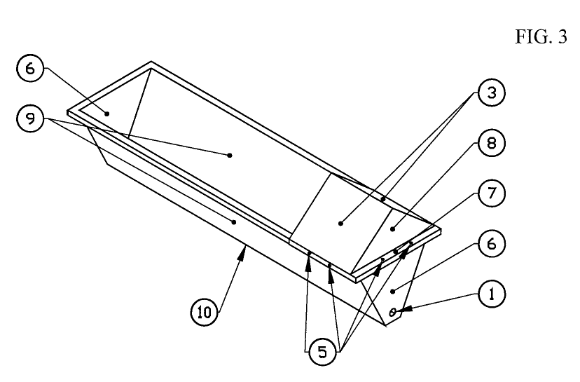

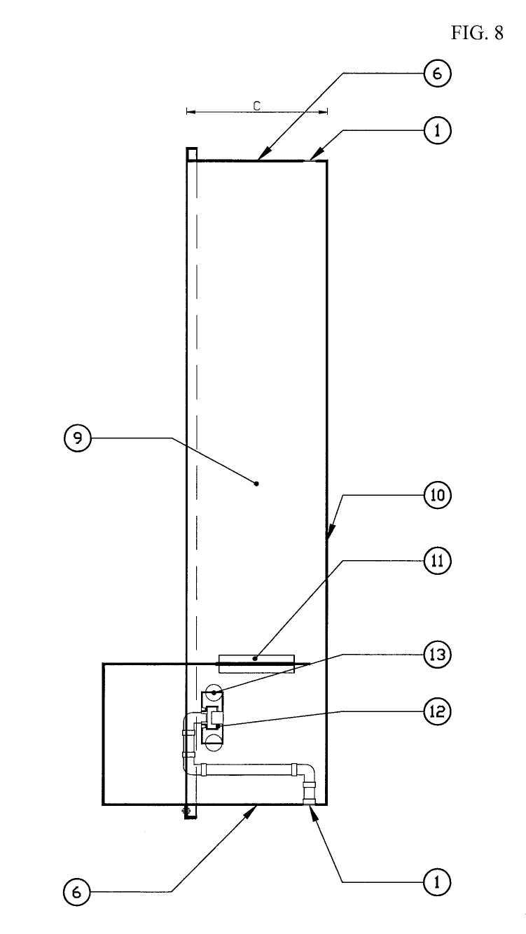

FIG. 008 shows that buoys (13) drive the water inlet and shutting off system (12). To prevent water contamination, the trough has a float protector consisting of a cover to protect the water supply/shutting off system, including two side protectors (2) and (8), a roof (3), a fold or flap (4) that connect it with the container and holes (5) for securing the protector to the container by means of bolts. In fact, as it can be seen in FIGS. 002 and 003, the water trough has a semi-submerged side cover (2) which protects the float from the animals' snout. In addition, the gable roof (3) prevents the animals from treading on the float equipment. The flap on the sides (4) and the flap on the rear side (7) allow the protector to be positioned and fixed to the container by means of bolts. The holes (5) allow the protective cap to be fixed also by means of bolts.

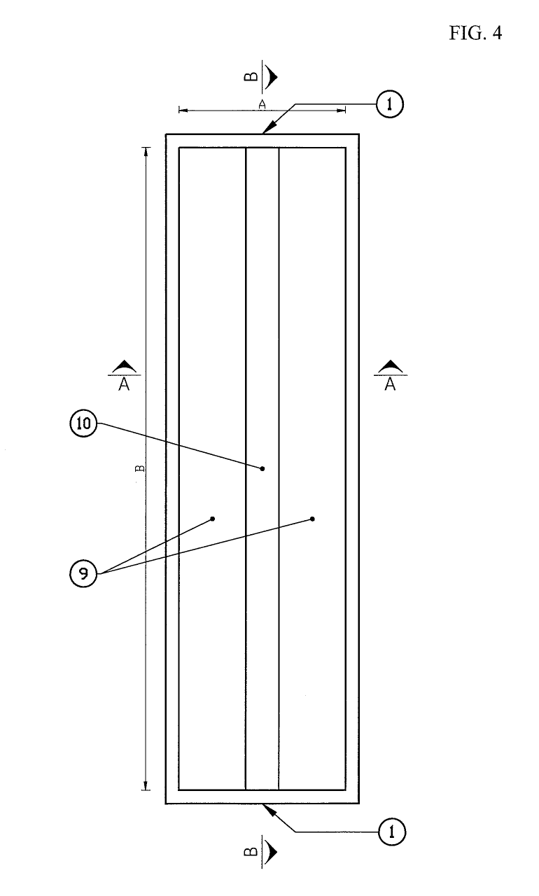

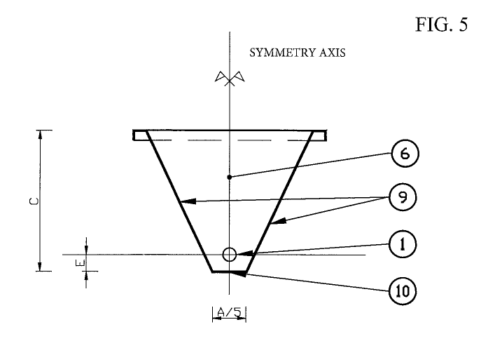

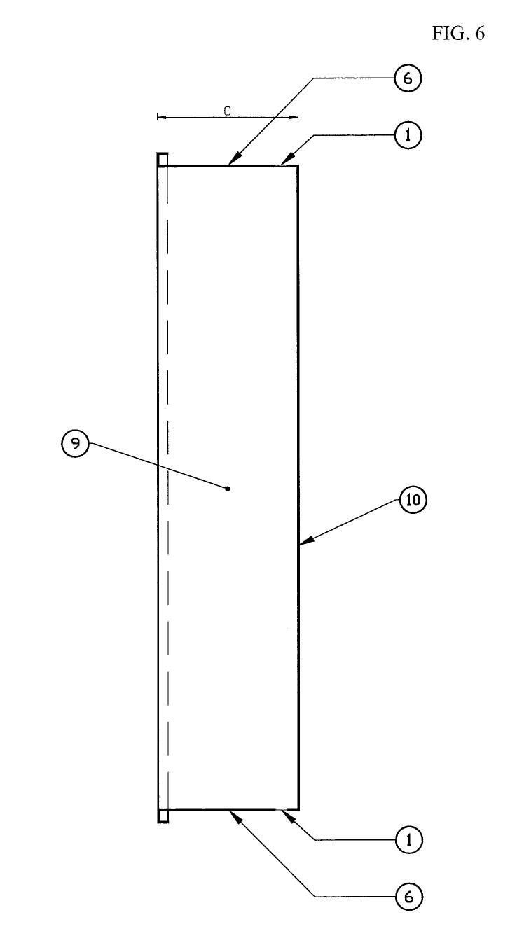

FIG. 004 shows the indications of sections A-A and B-B described in FIG. 005 and FIG. 006.

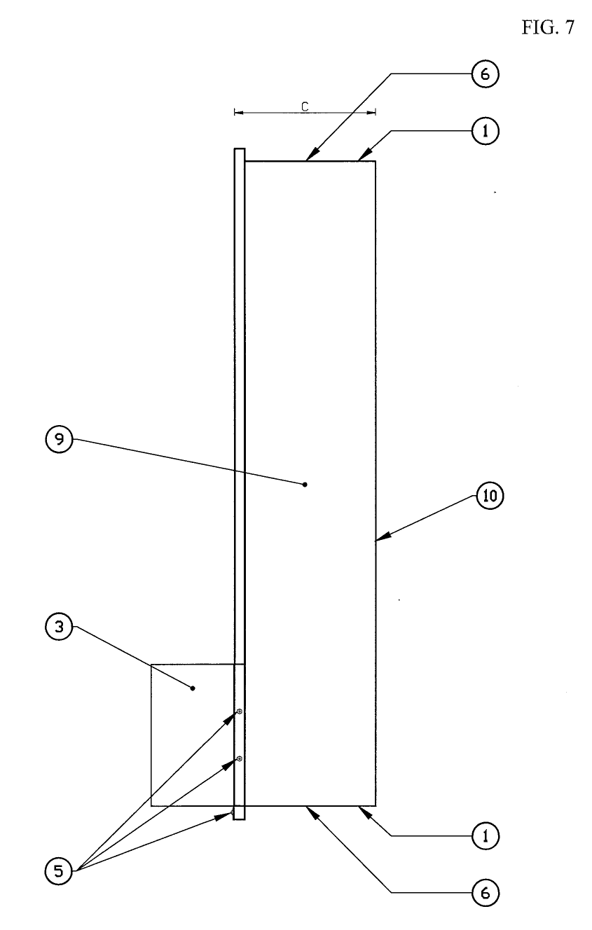

FIG. 007 shows the right and left sides of the water trough.

FIG. 008 shows the guides (11) for the semi-submerged cap (2).

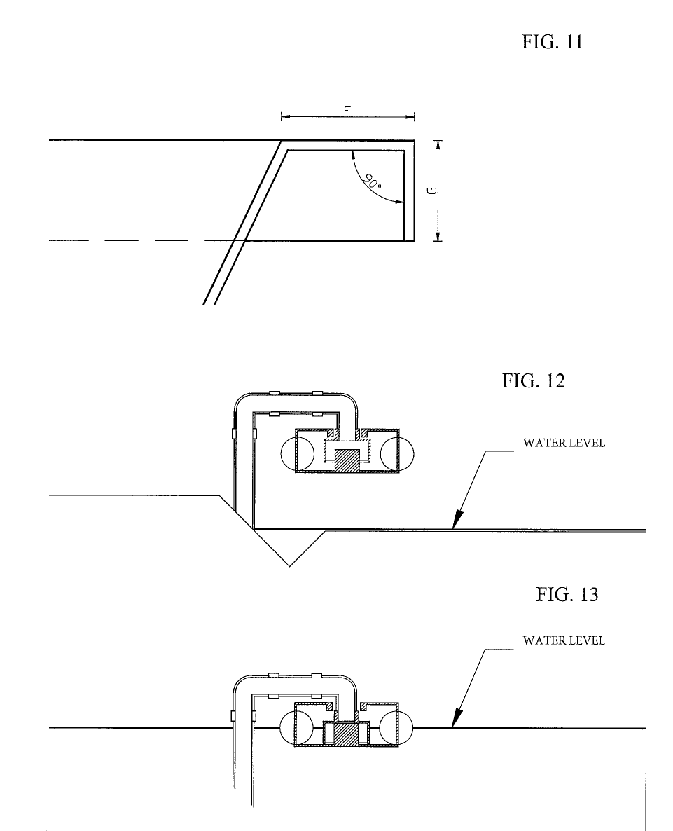

“Description X” of the container edge is specified in FIG. 011.

1. A livestock water trough characterized by:
a-Consists of a container or trough of a rectangular horizontal projection, which is placed at floor level, or semi buried; where the sides (6) of the trough are trapezoidal and the longitudinal sides (9) are rectangular and inclined:
b-Water is supplied through an orifice (1) from an underground pipe; water supply is controlled by any type of faucet commanded by a float (13); and wherein the float (13) drives a water inlet and a shutting off system (12);
c-he trough having a float protector comprising a cover with two side protectors (2) and (8), a roof (3), flaps that connect it with the container (4) and (7) and holes (5) for securing the protector to the container by means of bolts.

2. The livestock water trough of claim 1 wherein said water trough is constructed from metal (galvanized, stainless steel, painted sheet), reinforced concrete (with iron, with plastic fibers), ferrocement, wood or plastic.
